(19) United States
(12) Patent Application Publication
(10) Pub. No.: US 2002/0128895 A1
(43) Pub. Date: Sep. 12, 2002

(54) Project management method for optimizing information technology resources

(75) Inventors: Francis Ambrose Broderick, Rochester, NY (US); William Escott Fellows, Sanibel, FL (US); Carol Lynn McHattie, Apex, NC (US); Raymond Luis Ramirez, Danbury, CT (US)

Correspondence Address: IBM Corporation T81/062, PO Box 12195, Research Triangle Park, NC, 27709, US

(73) Assignee: International Business Machines Corporation, Armonk, NY

(21) Appl. No.: 10/042,625

(22) Filed: Jan. 9, 2002

(30) Foreign Application Priority Data
Jan. 11, 2001 (EP) 01480004.9

(51) Int. Cl. G06F 17/60

(52) U.S. Cl. 705/9

(57) ABSTRACT

A method for optimizing the Information Technology (IT) resources in a project, such as outsourcing services. These resources are IT sites comprising skilled people groups, and computer equipment spread over a geographic area. The main steps of the method are determining the number of IT sites, determining the skilled people groups and the computer equipment required inside the geographic area, centralizing or distributing the people and equipment over the IT sites inside the geographic area, and consolidating the IT sites. An additional step of standardizing processes and methods may be performed before the consolidation step. The use of a data base and a graphic user interface allows inclusion of feedback loops to improve the standardization step.

### FIELD OF THE INVENTION

The present invention generally relates to management of companies doing business with projects involving Information Technology service and manufacturing developments; more particularly, this invention relates to optimizing the resources involved in such projects.

### BACKGROUND OF THE INVENTION

A project management methodology in a company traditionally improves the communication system used between the project components and provides better control of schedules by the management. Many project management tools and systems are available today to share developer information and provide information to management on the status of the project.

A company doing business with projects needs also to provide management with tools that measure project costs. Activity-based costing (ABC) tools are available, as described in U.S. Pat. No. 5,799,286, which discloses an automated management system providing continuous, dynamic, and real-time costing information and reports. This solution implies the use of data bases and reports to help management with decisions regarding project costs.

However, it is strategic today to help international companies to optimize their resources in a broader sense. For instance, for a company doing business in information technology (IT) manufacturing or service development, the choice of skills to be developed by technical employees and the choice of computer sites and network equipment are strategic for success. Moreover, companies having international coverage face cultural differences including differences in languages and legal constraints. An appropriate management structure must be chosen for each culture. Furthermore, there is a need to develop strategic values for the company according to local and global business trends. Consequently, there is a need for a way of analyzing and adjusting the organization of the resources to match cultural needs and business trends.

### SUMMARY OF THE INVENTION

The invention includes a project management method for optimizing Information Technology sites comprising groups of skilled people and computer equipment. The method includes the steps of determining, according to the project business need, the number of IT sites spread over a geographic area; determining, according to the project technical need, the skilled people groups and the computer equipment required inside the geographic area; grouping and distributing, according to technical constraints, the skilled people groups and computer equipment over the IT sites inside the geographic area; and consolidating the IT sites of the geographic area with their skilled people groups and computer equipment by considering the project cost parameters and the geographic site location peculiarities.

The invention may further include a step of process and method standardization before the consolidating step. The process and method standardization step may include the steps of listing the processes and methods used in the IT sites as determined; listing criteria that enable assessment of the efficiency of the processes and methods in IT sites as determined and according to the skilled people group and computer equipment as determined, grouped, and distributed; determining the best processes and methods according to the value of the criteria; and implementing the best processes and methods in the IT sites as determined.

The method may also include the step of determining the best processes and methods by entering the value of the criteria into a database, creating with a graphic user interface an image of the evolution of the value of each criteria, and analyzing the images of the criteria for determining the best processes and methods. The use of a database and graphic user interface enable the user of feedback loops to improve the standardization step.

The standardization of procedures and practices across a wide geographic area makes the transfer of workload easier, reduces errors, and allows the organization's clients to be served the same way across international boundaries.

The consolidation of physical sites produces cost savings, as site support costs are reduced. Nevertheless, such savings should be weighed against the costs incurred by moving staff, paying off leases, and similar expenses.

A further advantage of the method is that it can be adapted to any type of client. It is not industry-specific, and may include manufacturing sites and support among company resources.

### BRIEF DESCRIPTION OF THE DRAWINGS

FIG. 1 illustrates the grouping of project resources in a geographic cell according to the present invention;

FIG. 2 illustrates the sequential phases of the method according to the present invention;

FIG. 3 illustrate the management organization of a project comprising more than one geocell according to step 8 of phase 1 of the present invention;

FIG. 4 illustrates the feedback loops of phase 2 of the method according to the present invention;

FIG. 5 is the print-out of a project management tool where all the steps of the preferred embodiment of the invention have been entered with a planned timing;

FIG. 6 illustrates an extension of the geocell organization, according to the present invention, from a country level to Europe.

### DESCRIPTION OF THE PREFERRED EMBODIMENT

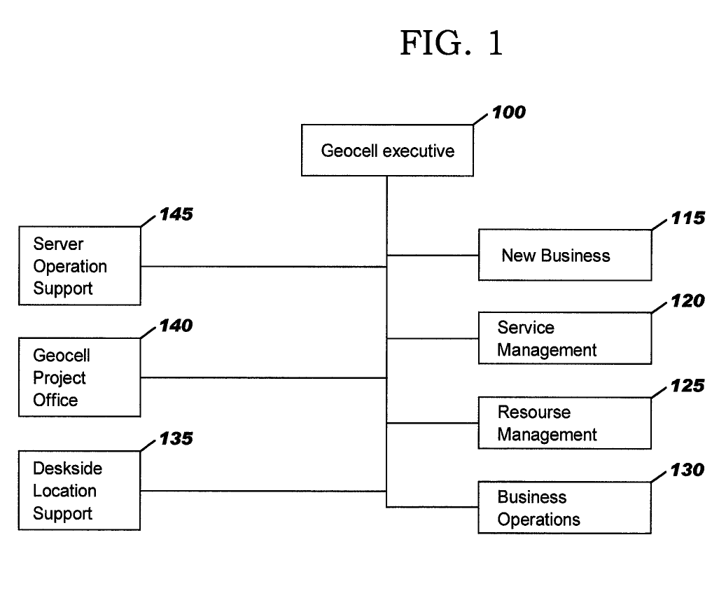

FIG. 1 shows an organizational scheme obtained by applying the method of the present invention to a company that does business in the field of IT projects. As an example, the project may consist of supporting clients who need outsourcing services. The company provides the clients with a hardware installation and remote support. Application of the inventive method may lead to the creation of new sites or relocalization of existing sites through a process of standardization and integration.

FIG. 1 shows a logical and physical organization of the various company sites participating in the project. The different sites that cooperate form a geographic cell called here a geocell. There may be one geocell per project, or one per sub project within a large project. For IT projects, the geocells include support centers, data processing equipment, and management project offices spread over geographic areas. In companies involved in manufacturing, the geocells may include the manufacturing plants.

Each geocell is associated with a single logical management structure and a unique management system. The parameters taken into account when optimizing the company's resources include differences in cultures, laws, and languages.

In FIG. 1, the project taken as an example involves European resources. The executive of the geocell (100) is located in Sweden. The project office (140) is located in France temporarily until completion of the execution of the inventive method. The first operational center of the geocell is the Server operation support (145) comprising system programmers, hardware and facilities, operations, tape, and print pools. The Server operations support (145) is located in England. The second operational center is the deskside location support (135), which is located in Spain. The deskside location support (135) comprises the Helpdesk, the deskside support, the procurement department, and the different location support. In this exemplary geocell, the people management and Human resources departments are included in the resource management center (125) in Italy. The service management (120) is in Germany. In this site are located the service analysts and the client managers. The business operations center (130), which is responsible for finance, planning, security and asset management, is in Italy. The new business central point (115) is in Denmark. This site provides the solution design, collects the requirements, and handles the project management through the closing of the geocell project office and the end of the project.

The decisions leading to the realization of an organization as illustrated in FIG. 1 are made by management in successive steps according to the method of the present invention, which defines the geocell.

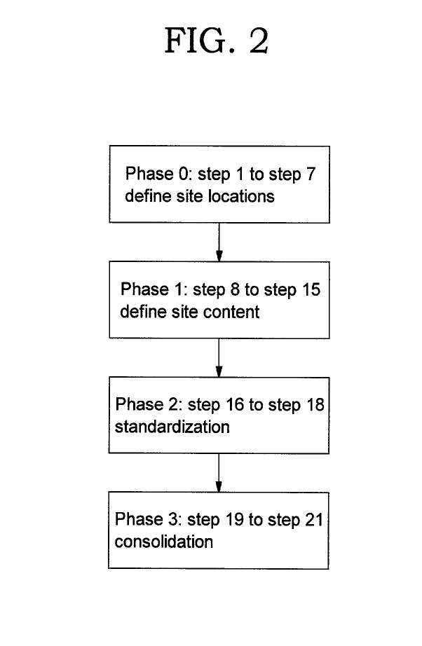

The method is executed in four phases as illustrated in FIG. 2. Phase 0 is for defining a priori the operational site locations contained in the geocell. To start a project, the company generally uses existing structures such as support centers and IT resources. The geocell definition is strategic, and this first phase is highly related to the knowledge of the business of the company. This first phase starts with an assumption of what should be the best geographic implementation for the different project resources. The method, in a preferred embodiment, completes the definition during the following two phases, and consolidates the resulting organization during the last phase (phase 3), the phase of consolidation.

Phase 1 performs the organizational integration. The integration may lead to immediate gains if more than one organization is merged with one other organization. In this phase the geocell's equipment and technical competence are defined, as well as the project management and the definition of which resources remain local and which are to be centralized.

Phase 2 performs standardization: this is a strategic phase in the method, as it is a step for validating and optimizing the choices of the previous phases. By evaluating the processes based on the physical and logical structures previously defined, this phase generates the most ambitious savings. With the use of a data base and a graphic user interface to visualize the data, a feedback loop improves the benefits expected during the execution of this phase.

Phase 3 performs physical consolidation of the geocells: at the end of phase 3, the resources of the company for the project are strategically implemented. At the end of the method, a unique geocell is defined for the project, or a geocell per sub project if the project is split into sub projects. The geocells are consolidated for the realization of the project up to its end.

Some steps are dependent upon the output of earlier steps, while other steps have no precursor. Depending on the exact characteristics of the organization performing the consolidation at the end of the process, it may be possible to run steps in parallel in order to shorten the total elapsed time taken by the project. Feedback loops are also implemented to improve step outputs during the execution of the method as in phase 2.

The time taken to perform each step is highly variable and depends on the complexity of the consolidation being attempted and the nature of the original organization. Rather than give an exact elapsed time for each step, the step description gives a relative time, and mentions actions or events which may make significant differences in the duration of the step.

The four phases contain a total of twenty-one steps in a preferred embodiment. Phase 0 contains the first seven steps, most of which must be complete or nearly complete prior to any general announcement of the formation of a geocell. As it occurs prior to geocell announcement, there are rarely any savings as a result of phase zero.

Phase 0 starts with a first step, step 1 to determine the number of geocells. This is the most important step in this phase. The number of geocells required depends on a number of factors both within the company and externally. Internal factors include market reach, future strategy, the physical location of existing sites, and the corporate culture. External factors include the political situation, economic factors, local language, and regional legislation.

If the consolidation exercise includes several different countries, it is not necessary for countries in a geocell to be physically adjacent, although having too many geographical divides does increase the difficulty of communication.

The result of this step is an exact definition of the scope of the geocell or geocells.

A prerequisite to this step is a thorough understanding of the business environment, future business direction, and the social and political environment in the concerned areas.

The duration of this step is variable, depending on gaps in knowledge and the commitment of senior executives.

Step 2: Appoint Geocell Executives

Each geocell requires a senior manager or executive (the exact reporting level will depend on the culture of the organization) who is dynamic, visionary, and able to see the wider picture across the entire geography of the geocell.

Any savings imposed on the organization ‘from above’ will probably be divided between geocells at this point.

A prerequisite to this step is Board level buy-in, which is part of the output from step 1.

The duration of this step is reasonably short, assuming a high degree of board-level buy-in.

Step 3: Produce Financial and Head Count Baseline

In order to measure future savings and understand the business at a geocell level, a financial and head count baseline is required for the entire geocell area. There are several key requirements for the baseline data, namely:

Collecting the data is not a single, unique operation. The baseline data will be continually updated and must therefore be stored in a medium capable of accepting updates with enough control around it to prevent either unauthorized tampering or errors resulting from multiple updates.

Depending on the diversity of the component parts of the organization, it may be necessary to perform a rationalization exercise during this step to ‘translate’ local names and skill descriptions into a common format.

The data collection mechanism needs a way in which it can be coordinated with the appropriate organization accounting mechanisms such as ledgers and accounts payable. Although it may not always be possible to perform exact one-to-one correlations between geocell data and organizational ledgers, exceptions should not be numerous. An agreed mechanism for resolving any mismatches is highly desirable.

If the geocell covers an area in which several currencies are used, an agreed mechanism of converting to a common currency is required. Although many multinational organizations have a ‘house currency’ it may be more convenient to use another base in certain situations. The baseline needs to be insulated in some way from currency fluctuations, which can make measuring the real savings almost impossible.

A prerequisite to this step is the output from step 1, probably including names from step 2 (although the process can start prior to executive appointment, there is no accountability or way to influence more reluctant parts of the organization until the executive is in place), staff to consolidate and correlate the data, and a central collection point defined.

The duration of this step depends on the scope of the geocell, willingness of different sites to work together, and the degree of commonality already existing in the reporting and accounting of various geographies. Theoretically this can be a very quick step; in practice, six elapsed weeks is a more reasonable estimate.

Step 4: Key Support Staff

It is necessary to put key support staff in place prior to performing any consolidation or geocell project work. The project offices are defined more exactly in steps five and eight; nevertheless, there are other staff who will need to devote considerable time and effort behind the scenes. The number of people required will depend on the size and scope of the geocell organization. The roles which need to be covered are:

Head count and resource tracking as defined in step 3

Communications, including the external press office

Client interfaces (if applicable)

Legal

Human Resources

Procurement

It is not necessary for all these roles to be filled full time, especially in the earlier portions of the project. Named resources are required, potentially at short notice as the project develops. It is helpful to agree who will be responsible for supporting which function in advance.

A prerequisite to this step is the output from step 1, and possibly the executive name from step 2 (for the reasons mentioned above).

The duration of this step depends on the degree of centralization of the functions within the existing organization and the scope of the geocell geography. If the consolidation is within one country this step will be quick. If it is multinational the step will be more complex.

Step 5: Set Up Central Project Office

This step is optional, and specific to certain situations.

A central project office is required only if the plan involves the creation of more than one geocell. If the consolidation is into a single geocell this step is not needed, as the actions performed by the central project office are not required. The local functions are found in step eight.

The role of the central project office is to coordinate the actions of individual geocell project offices, consolidate statistics and reporting for senior management, understand and facilitate common plan items, ensure all geocells are aware of the actions of others and their likely consequences, and make sure that lessons learned in one geocell are communicated to the others.

The central project office requires a leader with easy access to executive level management and one member in each geocell. Although holidays and similar absences need to be covered, there is little to gain by having additional people from the geocells in the central project office. The central office may also contain communications and administrative resources if the scope of the project so warrants.

Prerequisite to this step are Steps 1 and 2, and sometimes step 4, depending on the source of project office personnel.

The duration of this step is very quick once the appropriate people have been agreed.

Step 6: Understand Human Resource Situation

The human resource background needs to be thoroughly understood prior to making any plans for the geocell (or geocells). Key items which must be understood include:

The effects of local legislation on employee transfers

Comparative salary and benefits of the geographical areas involved in the geocell

Linguistic and cultural differences.

The best way to handle this step may be for central HR experts, with legal counsel if necessary, to work with local human resources personnel in order to build a list of effects that the local human resources environment will have on the geocell plan process. Where the geocell is completely within one country or a group of closely related countries (eg: USA/Canada, Norway/Sweden/Denmark, Australia/New Zealand, Syria/Jordan) the resulting list of differences which need to be taken into account may be short. In a more geographically diverse environment the list may include:

Plan delays required to allow consultation between management and workers' representatives such as works councils or unions

Actions required to obtain agreement in partially owned subsidiaries

Plan items required by law in one country or group of countries but not others

Differences in local accounting practices, currencies, and methods of doing business

Plan delays required to account for decision processes which rely on consensus rather than individual management

Employment legislation which stipulates that certain employees cannot be laid off or reassigned until a set of predetermined steps have been completed

The effect of local animosity between parts of the geocell (this may be taken into account in step one)

Diverse legal entities such as partly-owned subsidiaries

Prerequisite to this step are Steps 1 and 4. Steps 2 and 3 are helpful but not prerequisite.

The duration of this step is highly variable depending on geographic scope of the geocell and the degree of HR differences which exist.

Step 7: Produce Communications Plan

Unless there is only one geocell—in which case this step may optionally be absorbed into step 8—it is useful to provide some kind of overall communication plan for the activity. The communications plan has several elements, namely:

Communications within a geocell

Communications about common interests across all geocells

Communications to external organizations such as clients and suppliers

Corporate media communications

The scope of the communications plan, the means of delivery (e-mail, road shows, intranet etc), and the data feedlines into the communications office depend on the scope of the geocell and the culture of the organization. There may be three distinct stages to the communication offering, and the primary role of communications varies in each stage.

Geocell announcement. Defines the geocells and lets employees involved know what is happening. The primary role of communications in this stage is to inform and reassure during a period of change.

Ongoing plan execution. Regular status reports allow employees to make sense of the events happening around them. The primary role of communications at this point is to help build a shared sense of community. Because of the rate of change in the organization, it may be difficult to obtain information during this phase, and it may be necessary to allow extra time to solicit the project offices for data.

Termination. Signals the end of project mode and a return to ‘business as usual’, outlines the savings made and what this means in the future. The primary roles of communications in this phase are informative and congratulatory.

It is important that once the geocell project finishes, a means of communications is left in place to allow future team building and ongoing data cascade.

Prerequisite to this step are Step 4 and Step 5 if applicable. Step 6 is helpful in developing the strategy for communications but not an absolute prerequisite.

The duration of this step is reasonably short since the activity is ‘stand alone’ once the prerequisite steps are in place.

Phase 1

Phase 1 defines site contents. In this phase is performed the organizational integration. The organizational integration phase contains eight of the twenty-one steps which build the management structure and management system. Organizational changes will produce some savings, especially in client-facing positions such as service management.

Step 8: Set Up Individual Geocell Project Office

The geocell project office includes the overall project manager, any sub-project managers, administrative resources, and one person in the central project office, if one exists. The role of the project office is to run the geocell project within the scope of the geocell and, as such, its first key deliverable is the high level plan for completing the remaining steps of the plan.

It has been found helpful if:

The overall project manager reports directly to the geocell executive for the duration of the project

The central project office representative for the geocell and the geocell project manager update each other at least weekly

The baseline and measurements data collection professionals are included in the project office for the duration of the project

The project office has rapid access to both HR and legal advice

The project office has a means of linking with any previously-created geocells to learn from their experiences

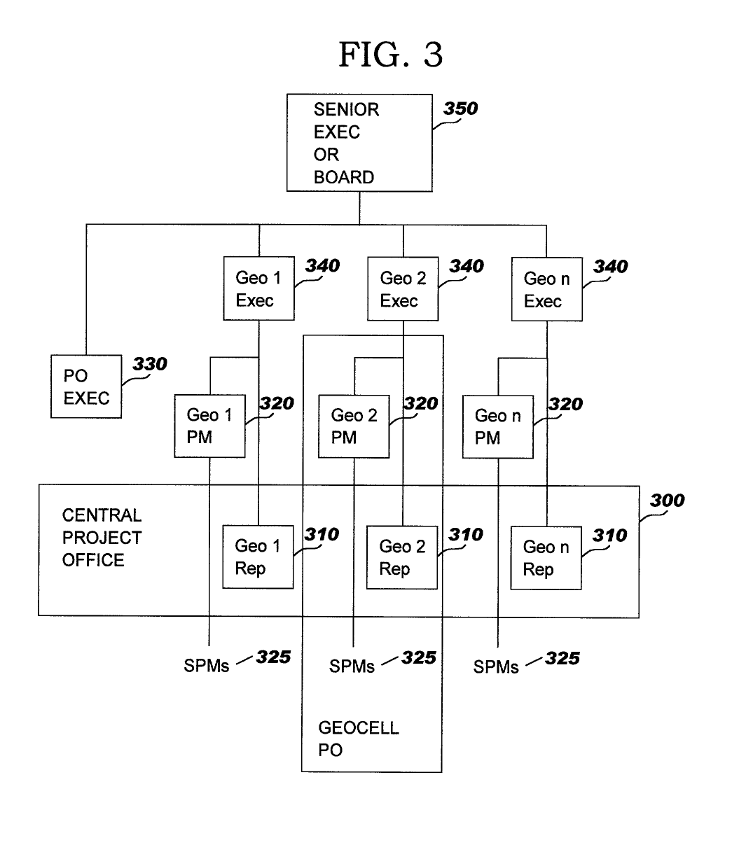

If there is more than one geocell it is not necessary for the project offices to be constructed in the same way. Assuming the existence of a central project office, the final project management structure may have the structure shown in FIG. 3. The central project office (300) includes a representative (310) of each geocell. Each geocell project office includes a representative in the geocell project office, the project (320) and sub project (325) management. The executive groups are the project office executives (330) and the different geocell executives (340). Top executives for the entire project are the senior executives (350).

A prerequisite to this step is that most of phase 0 should have completed by this stage. The duration of this step is very short.

Step 9: Develop New Organization

It is up to the geocell executive to develop his or her organization, taking into account the geographic spread of the geocell, existing organization, future plans, and internal politics. As discussed in step 10 (below), it is not necessary to define the entire organization, only the high level outline which should be by functional group rather than geographic position.

Management should be arranged by functional group wherever possible. Direct reports to the geocell executive should have functional responsibility across all geographies or sites included in the geocell or the full level of savings may not be realized. Although some functions are difficult to centralize (for example, service management staff tend to need to be physically near their client), there is no reason why the management of such functions should not be centralized.

A geocell executive may wish to appoint an overall steering committee at this point to review progress of the project. This may be helpful but is not an absolute requirement.

Where there is more than one geocell it is not necessary for each one to have the same organizational structure.

A prerequisite to this step is to have Phase 0 complete or mostly complete. Step 6 is critical.

The duration of this step depends on the politics of the organization and the decision making process. Indecisive executives or those in countries which require prolonged consultation prior to decision making may take a considerable time with this step.

Step 10: Appoint New Management Team

This step involves fleshing out the skeleton organization created by the geocell executive by appointing specific people into the positions defined. Again, the decision making method and the politics of the organization may determine how long this step takes.

Once the functional managers are appointed, each one needs to further define his or her organization. This may require input from steps 3, 4, 6, 11 and 15.

The following guidelines have been found to be helpful but they are not obligatory and may not necessarily apply to all organizations:

There should be no more than three layers of management below the geocell executive, regardless of the size of the organization

The span of control should be maximized

Management should be arranged by functional group wherever possible. Although some functions are difficult to centralize (for example, service management staff tend to need to be physically near their clients) there is no reason why the management of such functions should not be centralized.

It is desirable to have representation from several constituent countries in the senior management team as this encourages participation across the physical geography and maximizes the breadth of local experience available at senior levels.

The best appointees do not always reside in the senior levels of the component organizations, but may be one level down. Unless the geocell is very small, it is unlikely that people more than one level down will have had sufficient management experience to hold a senior geocell role.

With a functional top layer of management within the geocell, the second layer should generally not be geographically aligned, or the full level of savings may not be realized. Service Management, Resource Management, and Legal groups may well be exceptions to this rule.

Most countries require that an employee has an ‘in country’ career manager for tax and legal reasons. A resource/task manager split is a viable way around this requirement where it exists.

Depending on the preferred method of working, each functional manager may be asked to provide a sub-project manager to the geocell project office.

At the end of step 10 the organization should be complete to the level that each individual employee knows his or her reporting chain both for task and, if different, personal management. The organization will be balanced, understood, and within legal and HR guidelines.

A typical organization structure is shown in FIG. 1 and has been already commented above.

A prerequisite to this step is Steps 2, 6 and 9 for the management appointment. Input from steps 3, 4, 6, 11 and 15 may be required to build the entire organization.

Unless the geocell is very small, it will typically take several months to progress from initial agreement of the high level organization created in step 9 to the completion of this task.

Step 11: Geocell Profile

The creation of a geocell profile is essential to the completion of most of the following steps. The profile is a listing of the resources in a geocell, their locations, and uses. A typical profile may contain the following information:

The size, location, and type of all servers, major network termination boxes, and key items of hardware

The software running on each server

The skill profile of everyone in the geocell plus their physical location and reporting line

All the clients supported by the services listed above, and which components are used to support which clients

Information on physical sites within the geocell

Some of this data may be easily available—the output from step 3 is helpful in consolidating skills and much of the rest may be available from asset management. However, in some organizations the data is fragmented or so out of date that a complete inventory is required. Once the profile is complete, management should be able to identify what resources are where and which resources are used to support what parts of the business. Isolated skills or equipment should also be easily recognizable.

The following points may be helpful when compiling the profile for the geocell:

There is no ‘right’ way to present the data, and if there is more than one geocell it is not necessary for all geocells to consolidate their data in the same way. Often the format will be defined by which reports are easily available. However, a common nomenclature and overall framework will facilitate the task, as well as making and additional geocell activity easier.

The profile leans heavily on the output from step 3, the completion of which is a major help when building the skills part of the profile.

Asset management is likely to be the prime source of data for everything other than skills. A good asset management method significantly reduces the complexity of this task.

The profile data is not static, and a mechanism is needed to keep it up to date responsive to equipment, site, or infrastructure changes.

Where data isn't available within a reasonable time frame it is possible to proceed without it as long as no key decision is based on a simple guess or extrapolation.

It is helpful to define a cut-off level for data below which information need not be collected. For example, it may be sufficient to say that there are 100 desktops at site X. The fact that 93 are Windows 95, 5 OS/2 and 2 Unix may not be important. Defining the cut-off point for data can also save time in the process.

The completed profile may be a key descriptor document of the entire geocell and should therefore be treated with sensitivity. Where security classifications exist within the organization the profile document should be classed accordingly.

A prerequisite to this step is Step 4. Data from steps 3, 9 and 10 may be useful but as the profile can take a long time to create there is benefit to kicking off the work as soon as possible.

The duration of this step is highly variable depending on availability and reliability of the source data, the size of the geocell, and the number of people available to collate the results. Assuming no major delays collecting data, and two people to collate, the task may take about a month for a reasonably sized geocell.

Step 12: Integrate ‘Quick Wins’

The profile from step 11 and the output for phase 0 may allow management to identify ‘quick wins’—savings which can be made quickly and easily. Although such savings may be small, there are several benefits to taking them sooner rather than later:

The quick win provides evidence—via the communication process—that the geocell can deliver on its earlier promises.

Depending on the size of the geocell, there are potentially several quick wins available which add together to a significant saving, especially since the resources are saved early.

By moving quickly wherever possible, the planning is simplified and there is less chance of a small saving being forgotten.

The nature of ‘quick wins’ may differ from geocell to geocell depending on the social, political, and geographic factors. The existing client portfolio and locations of key suppliers and clients may also have an effect. Candidates for quick wins include:

Redeploying or removing single items of equipment;

Adjusting workloads and responsibilities where isolated skill groups exist;

Closing or reassigning space in sites with low floor space utilization; and

Planning consolidated education rather than on a site-by-site basis.

This does not mean that every incidence of the above will automatically be a quick win, but there should be enough potential savings to warrant the investigation.

Prerequisite to this step are the geocell profile from step 11 and phase 0 virtually complete.

Identifying quick wins should be fairly rapid once the profile is available. Implementing them may take much longer especially if some of the delays listed in step 6 occur or if it is more efficient to group quick wins for ease of implementation.

Step 13: Determine Central .v. Local

Once the profile from step 11 is available, it is possible to identify which items can potentially be centralized. Within a geocell there will always be items which must remain local. Step 13 is where they are identified. At the end of this step the resources available to a geocell will be categorized into four groups:

Resources which can be centralized. Examples of such resources are servers that can be moved into server farms, or a small satellite site that can be absorbed by a neighboring large site.

Resources which could be centralized but where there are convincing technical or organizational reasons why such centralization may be unadvisable. An example of this is an e-mail server located in a specific site to provide e-mail connections between the users of that site in order to minimize bandwidth or improve delivery times. Removal of such a server would severely impact the users of the site and increase bandwidth requirements.

Resources which could be centralized but where there is a sound cost reason for not moving them. If the cost of moving a resource is greater than the cost of keeping it where it is there is no point in considering a move unless a big gain can be obtained elsewhere. For example, if it costs more to move an isolated group of ten systems programmers than to keep their desks at a remote site, the move is pointless unless it has an add-on saving such as allowing an entire site closure.

Resources which must remain local. Examples of such resources are those contractually located on a client site or linked to other equipment which cannot be moved.

Once the resources that must remain local are agreed, they may be removed from any further planning.

There may be some non-technical reasons why functions or equipment must remain local. A list of possible causes is given in the description of step 6. One possible way to address this is given in the ‘lessons learned’ section.

Prerequisite to this step are Steps 6 and 11.

The duration of this step is comparatively short once the profile is available unless there is a prolonged debate about technical effects. An elapsed month should be sufficient time for all but the largest and most complex geocells. This step may run in parallel with step 12 as it uses most of the same input data.

Step 14: Develop Management System

This step may include two management systems. The first is the overall geocell management system, which needs to be prepared first either by the project office or the geocell executive's staff group. This management system should be able to support any higher corporate objectives while allowing timely management of the geocell.

The second management system is the one used to support the overall management system, which is created by each of the functional managers. Again, this system may be created by the project office or by staff personnel within each functional group.

The implementation of the management system may include the following:

Interlock with other geocells if required. The management system need not be identical to that in any other geocells as long as they interlink where needed and all geocells follow a standard form.

Interlock with the requirements of the organization board or senior management

Timely reporting and feedback

A means of managing out of line situations (good and bad) and bringing them back in line where necessary

A means of accommodating the legal, linguistic, and cultural diversity which may exist within the geocell

Prerequisite to this step are Steps 6 and 10.

The duration of this step depends on the decision making process but typically is rapid for even large and complex geocells.

Step 15: Perform Skill Analysis

Each functional group should perform a detailed skill analysis of the people within its scope of control and understand where there are gaps and overlaps. Once understood, the information may be consolidated into quick wins or used to build the lower levels of the final organization. Much of the data may be lifted directly from step 3, but it may be helpful to use greater granularity in this step. Further:

This step may provide a way of evaluating the suitability of possible second line managers

It is possible to identify potential quick wins from this step, although isolated skill pockets do not always equate to a quick win. Before determining whether consolidating isolated skills is a quick win or not, it is necessary to understand the entire local environment—the skill data collected here is not sufficient alone

In geocells which cover several diverse countries, language issues may force the retention of isolated skill pockets

Prerequisite to this step are Steps 3 and 6 and the first part of step 10.

The duration of this step is related to the completeness of data from step 3 and the size of the geocell. This step may be very quick.

Phase 2

Phase 2 is the standardization phase. It contains three steps of the twenty-one step plan and concerns the consolidation of processes and procedures. This is the phase which realizes most savings as standardization and streamlining often produce considerable productivity benefits.

Step 16: Understand Processes and Methods

In order to standardize processes it is necessary to understand what processes are in use and for which purposes. In some organizations this may be dictated ‘top down’, which means that there will be little local divergence. In other organizations each site or country may have evolved its own processes resulting in considerable differences. The questions which should be answered in this step are:

Which processes are in use and what do they do?

Who uses them?

What tools and methodologies are in place to support each one?

Once these questions are answered, it is helpful to apply the results of step 13 to understand if there are any processes which, for any reason, cannot be altered. If so, various aspects of the process may be placed out of scope.

Prerequisite to this step is that Phase 0 should be complete. This step is purely investigative. If the people are available to perform the analysis it does not depend on organizational aspects.

The duration of this step depends on the number of processes in scope and the size and cultural diversity of the geocell. This may be a massive task. It is possible to run the three steps in phase two roughly in parallel as long as this step is given a slight head start in order to provide information which can be used in the two following steps. In small organizations where the processes are imposed ‘top down’ this step may be comparatively simple.

Step 17: Assess Processes and Methods and Understand Best of Breed

Assessment of the processes located in step 16 has three stages.

Determine and agree on the assessment criteria. In some cases this may be facilitated by having benchmark data, but in many cases it will be open to debate.

Determine the definition of ‘best of breed’. Many processes are unlikely to contain metrics, and the definition of which version performs best is often purely subjective. It may be necessary to standardize terminology and process scope before this task can be performed. There are three tactics which may be used to determine ‘best of breed’, which are discussed later in this section.

Determine which processes need to be changed. There are four considerations involved in this decision. Firstly, some processes may be so specialized or so close to the ‘ideal’ that there is no benefit to tinkering for the minimal improvement which might result. Secondly, it is possible that later events will make the need for change obsolete (for example, there is little benefit to changing the problem management process at site X if site X will be closed in the next three months). A clear set of priorities by comparing the entire plan is therefore needed. Thirdly, a process may be closely interlinked with other methods and processes within the geocell so that any change might have a widespread disruptive effect. In such cases the additional disruption may prove to be a barrier to any change of the original process, however nonstandard it is. Finally, it could be that the process affects so few people that standardization simply is not worth the effort.

The three tactics which can be used to standardize on the ‘best of breed’ are:

Where processes are essentially imposed from elsewhere, whether this is higher up the organization or from an external agency, the imposed process is the best by definition. It could be argued that if there are several geocells, the method adopted by the majority is the best even though it might not be necessary for different geocells to standardize their processes.

Where some metrics exist, even if they are incomplete, a more objective method may be used to determine the best of breed. For example, even if a problem management process produces no metrics itself, it may be possible to compare the number of people involved or user's perceptions of the fix time.

Where the goal is simply standardization to reduce overhead, the most common process may be the best. ‘The best’ is defined as the method used by the majority, even if this is in some ways inferior to the alternatives.

There are two ways to assess processes in the geocell. Either a dedicated group of process experts reviews all processes or each functional manager forms a team to review the processes which directly affect him or her. Although there may be debates about who owns various cross-functional processes, the second method has been found to be superior in most cases.

Prerequisite to this step is having all previous steps, except 12, 14, and 15, complete or nearly complete.

This step may involve considerable, and occasionally acrimonious, debate, and the time it will take should not be underestimated. Even a small geocell may have twenty processes which need to be standardized and it is quite possible for this step to last a year. Fortunately, as stated in step 16 above, it is possible to run this step substantially in parallel with steps 16 and 18.

Step 18: Implement Processes

The standardization of processes is a sub project in itself. Standardization can range from minor definition adjustments to the replacement of supporting tools or the replacement of entire processes by new ones. Which degree of change is needed for which process depends totally on the local conditions within the geocell and cannot be predicted. However, some factors may affect the degree of change allowed, namely:

The resources available to perform the change and any follow on activity (eg: education)

Disruption to ongoing business. Internal disruption will require management focus and control to prevent it from becoming visible to client organizations while the changes are occurring. Practices such as dual running or phased installations may need to be considered to insulate clients from the effects of the change. It may be helpful to proceed at a slower than optimum rate in order to protect the integrity of client-facing processes.

Where the resources are stretched and the disruption is high, there should be a convincing case to take the maximum change option. The advantages and disadvantages of each degree of change are explained below.

If the option is to perform only minor changes, the advantages are a minimal disruption, a step quick to perform, and a low resource requirement. The disadvantages are that this solution may be used advantageously only when processes are slightly divergent, and that it may not provide sufficient standardization to realize savings.

If the option is to rework tools or implementation methods but not to change basic process, the advantages are:

A higher degree of standardization

Lower resource requirements

Lower license costs

Easier support once the conversion is completed

Easier comparison

The disadvantages of reworking tools or implementation methods but not changing basic process are:

It can result in a high degree of internal disruption requiring careful management to shield clients

It needs to retrain some or all users of the process

It may require follow-on changes in areas which don't really need changing

There may be language or cultural issues

If the option is to perform major changes, the advantages are:

The highest degree of standardization, hence the highest savings in people, time, efficiency, license costs, etc.

Easier process comparison

Simplified centralization

If the option is to perform major changes, the disadvantages are:

Usually considerable internal disruption requiring management effort to shield clients from the effects.

Post-change education, documentation, etc. can be a big task in its own right

Requires changes to all interfaces

May be language or cultural issues

Of course, it is possible that a process will require the highest degree of change in only limited sites or countries within the geocell.

A prerequisite to this step is Step 17 (at least for the processes to be modified).

The duration of this step is highly variable but typically 12 to 24 months for a large geocell. As stated earlier, this step may run substantially in parallel with steps 16 and 17.

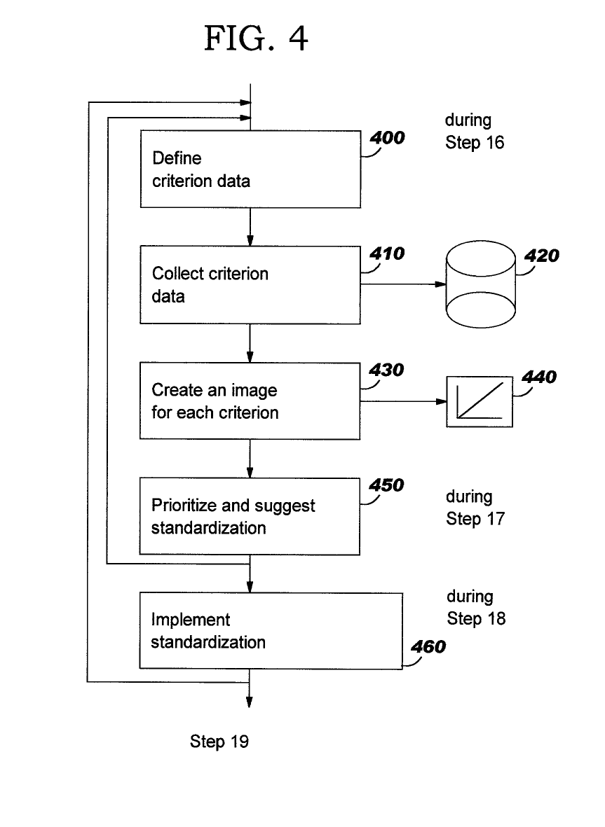

FIG. 4 illustrates the use of a database (420) and a graphic user interface to access the data in a feedback loop that includes the three steps of phase 3. During step 16 of defining processes and methods, a list of criteria is defined (400) to measure processes and methods. The criteria may be the distribution of IT software tools or hardware equipment used, the number of skilled people, and so forth. Using a graphic user interface, images (440) of the criteria at a given time of the project development are issued (430). During step 17, a step of prioritization (450) is performed, with the help of the image. A standardization is suggested. On the basis of this suggested standardization, the criteria characterizing the standardized processes and methods are reviewed again (400). The collection of data (410), the creation of images (430), and a new prioritization step (450) are performed again. After performing such a feedback loop, the standardization is improved. Implementation of the standardization is begun (460) with step 18.

After this experiment a new review of the processes and methods criteria is performed (400, 410, 430, 450, 460). This later feedback loop may lead to adjustments and a better standardization and thus saving results.

Phase 3

Phase 3 is the final phase, and contains the last three steps of the twenty-one, which are concerned with physical consolidation. This phase does not usually realize significant head count savings, but does bring cost reductions associated with the smaller property portfolio.

Step 19: Site Strategy

This step defines a cohesive site strategy for the geocell. The site strategy is the blueprint used to consolidate physical sites to the optimum number, which may or may not be the same as the minimum number. Factors which affect site strategy are:

Skills. Where a site has a critical mass of several skills the cost of relocating the skill base can be prohibitive. There is also a danger of the skill base being severely eroded by voluntary severance, especially when there are alternative employers nearby.

Technology. The availability of technology or the cost of transferring it may limit the options available. This is especially true with larger or older equipment which often has more restrictive environmental requirements such as a cooling water supply or humidity control.

Infrastructure. The quality of the supporting infrastructure is critical to a site, especially a site that contains a large number of servers. Dual power supplies, UPS/CPS, proximity to local transport links, proximity to third party support (eg: hardware engineers) and the attitude of the local government authority can all be limiting factors, not all of which may be easily overcome.

Clients. Certain resources may need to be close to client locations. Resources co-located with clients are not usually candidates for a move out, although it may be possible, with the client's agreement, to move additional resources into the client site. This approach is cheaper but does have associated risks.

Contractual and legal issues. Legal issues may restrict site consolidation options. For example, there may be legislation which restricts the physical location of operations staff with access to sensitive data (eg: Norway), legislation which controls encryption requirements (eg: the US) or controls on the way personal data is handled (eg: the EEC). There may also be clauses in existing client contracts which limit the options available. While these may possibly be renegotiated, the process can be time consuming.

Ownership. The ownership of a site is a limiting factor. While the organization may own a site outright, the site may also be leased, jointly owned, or be a client site occupied by the organization's resources. In the first case, restrictions are unlikely; however, there are possible implications in the others.

Organization strategy. The organization may require certain sites for the successful implementation of its future strategy.

Service considerations. Closure of too many sites leaves an organization unable to recover in the event of a disaster. While the risk may be small, the loss of a significant portion of an organization's IT resources could be fatal in the modern e-business world.

Social constraints. Some societies have a degree of social stratification such that there may be considerable political fallout if relocations or closures hit one stratum harder than another. The HR specialists (see step 6) are invaluable in understanding this effect and minimizing its effects.

The mechanism used to develop a cohesive site strategy will depend on the organization, the degree of centralization of the existing property portfolio, and how widespread the sites within the geocell are. Although the size of the site clearly determines how easy it is to relocate the resources it contains, small sites should not necessarily always be consolidated into larger ones.

Prerequisite to this step are Phase 0 and most of Phase 1.

The duration of this step depends on the size of the existing geocell portfolio, the decision making process and the number of extraneous external factors. There may be little correlation between any of these factors and the time taken.

Step 20: Centralize Asset Management and Planning

Centralization of asset control and the associated disciplines of procurement and physical audit may provide large savings in two ways:

Equipment standardization and reuse is facilitated, resulting in lower reorder and support costs.

The negotiating power of an organization is greater if it negotiates on behalf of a geocell rather than site-by-site or country-by-country.

The means by which asset control is consolidated depends on the degree of centralization already present in the organization. Consolidation of asset control may be delayed if the supporting financial processes require prior consolidation. If so, there is a strong case for making any associated financial processes the first ones to be reviewed in phase 2.

The mechanisms required to perform consolidated asset control are likely to be in place for larger assets, such as mainframes, but not for smaller ones—especially disposable ones such as floppy disks. The degree of effort required to centralize control of smaller components, and the bureaucratic inefficiencies which may be generated as a result, may be prohibitive to centralizing control of small disposable assets such as printer cartridges or paper. The best method may be to appoint preferred suppliers for smaller items and centralize control of larger ones, with individual PCs being a reasonable cut off point. The level of control should be approved the by the geocell executive(s).

Prerequisite to this step are Phase 0, and Phase 2 for financial services if financial consolidation is required.

The duration of this step depends on the number of resources, the agreed scope of asset control, and the decision making process. For a geocell with a variety of sites and currencies, this step may take between six and twelve months.

Step 21: Perform Physical Consolidation

Once the prerequisite steps have been completed, it is possible to perform the agreed site consolidations. Each consolidation will be a subproject in its own right which may last over several years. Larger consolidation subprojects may require their own project offices with associated communications and administrative staffs.

If the twenty-one step method has been followed, all prerequisite actions should have been taken and issues such as HR considerations, overall site strategy, and the location of skilled resources will have been resolved.

Prerequisite to this step are Steps 3, 4, 6, 11, 15 and 19.

The duration of this step is highly variable depending on scope and complexity. It may take up to two years to complete the consolidations in a medium to large geocell.

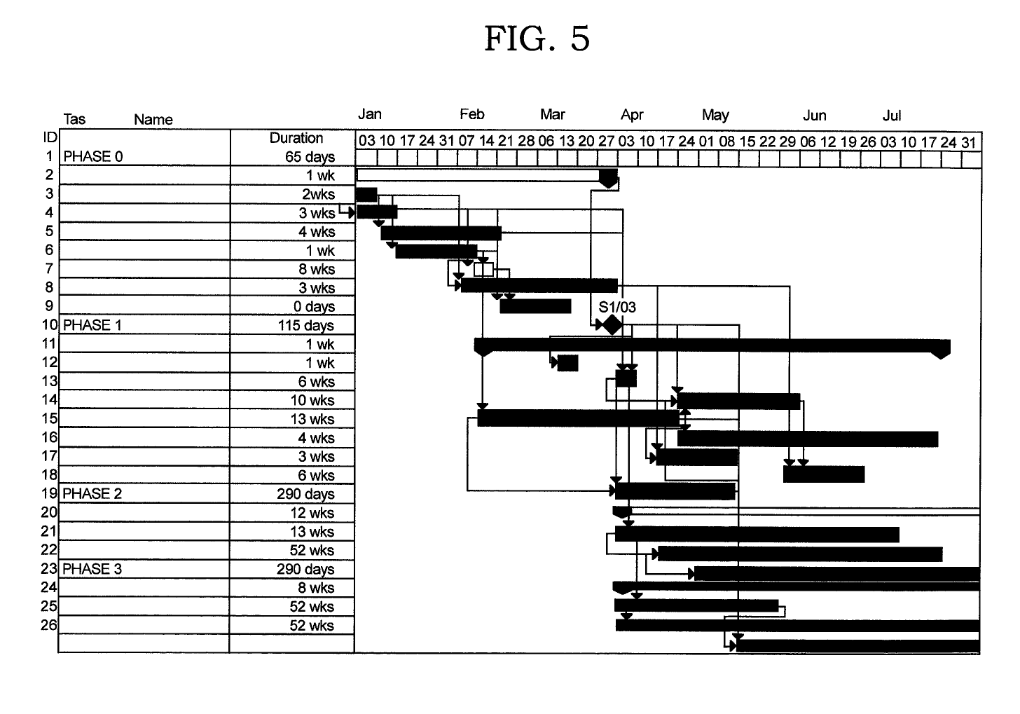

FIG. 5 shows a Gantt chart that illustrates the project schedule based on the method of the preferred embodiment as graphically displayed by a project management tool such as Microsoft Office 2000. Gantt charts are the common representation used by the various project management tools. For instance, the duration of phase 0 takes 65 days. The ids from 2 to 9 of the left column represent steps 1 to 8. The tool provides a calendar schedule represented with horizontal bars. This schedule takes into account the dependencies of one step on the other according to the step description.

The following plan outlines the key points. Tasks 22 (step 18), 25 (step 20) and 26 (step 21) have been truncated for ease of printing. On this plan the overall finish date is in the second quarter of next year.

The plan assumes five-day work weeks without intervening holidays. An allowance for local vacations will therefore need to be added into the plan. A moderate degree of negotiation time has been included, but in cultures where there is a prolonged decision making process or strict employment legislation some steps—especially steps 6, 18, 19 and 21—may need to be considerably extended. The plan starts on 1st January in order to make the elapsed times clear.

The project management tools reflect in which order the steps of the method should be performed to take best advantage of the method.

Table 1 and table 2 give an evaluation of the expected savings in headcount terms. Table 1 should be used when the environment is essentially homogeneous and table 2 when the environment is more diverse. Homogenous environments share a common language, legal, and cultural structure. A typical homogenous environment is the USA where, although each state has a slightly different legal system, there is a common federal framework and language. Another homogenous environment would be where an organization contains subsidiary organizations which, even if not fully owned by the parent organization, share a common legal framework and corporate vision.

Heterogeneous environments contain a diversity of cultures, languages and political systems, and are typical of most of Europe, the Near- and Middle-East, Asia Pacific, and Africa.

TABLE 1

| | Typical | Phase | Phase | Phase | Phase |
|---|---|---|---|---|---|
| Skill group | org. | 0 | 1 | 2 | 3 |
| Technical Support | 35% | Nil | 10% | 20% | 5% |
| Business Management | 8% | Nil | Nil | 10% | 5% |
| Service Management | 20% | Nil | 20% | Nil | Nil |
| Help desk&Desk side | 23% | Nil | 10% | 10% | 5% |
| Operations | 10% | Nil | 10% | 15% | 5% |
| Others | 5% | Nil | 10% | 12% | Nil |

TABLE 2

| | Typical | Phase | Phase | Phase | Phase |
|---|---|---|---|---|---|
| Skill group | org. | 0 | 1 | 2 | 3 |
| Technical Support | 35% | Nil | 5% | 10% | 2% |
| Business Management | 8% | Nil | Nil | 5% | 2% |
| Service Management | 20% | Nil | 10% | Nil | Nil |
| Help desk&Desk side | 23% | Nil | 5% | 5% | 3% |
| Operations | 10% | Nil | 5% | 7% | 3% |
| Others | 5% | Nil | 5% | 6% | Nil |

The tables show the main skill groups found in a typical computer organization and the percentage of the total organization which forms each group.

The different kinds of skills in each group within a typical computer center may be at least eight. The first skill for Business Operations comprises financial specialists, planners, and specialists for security—both physical and logical—, business control, procurement, asset management, communications, space planning, Quality Assurance, and process management.

The Desk side support skill group comprises technical people for Desktop and cable layers, desktop engineers and local LAN, token ring, or Ethernet managers. The skill group for Help desk support comprises Help desk agents, first line technical support, and user administration people. The skill group for Operations comprises Console operators and operators for tape operations, tape libraries, archives, and printers. The skill group for Resources Management comprises people managers and specialists for recruitment and education. The skill group for Service Management comprises Customer facing executives, service managers, and service analysts. The skill group for Solutions Management comprises Solution designers, project managers, and transition specialists. The skill group for Technical Support comprises systems programmers for all platforms, hardware planners, site facilities planners, technical solution designers, and technical planning.

It should be emphasized that the typical organization figures assume a wide spread of available technology. Organizations which are highly oriented towards a particular type of technology, such as mainframe or client/server, will show a skew in these figures.

The last four columns of Table 1 and Table 2 show the expected head count savings achievable, expressed as a percentage of the original head count.

It is theoretically possible to continue geocell activity to consolidate still further if needed. In practice this requires that any intermediate stage of the process is allowed to reach equilibrium, and that any intermediate geocells are made as similar as possible to allow further consolidation. Items which may determine the ability to structure by geocell further include:

Local cultural and legal issues

Practicality of operations (such as disaster recovery, provision of sufficient local work forces etc.)

Internal morale and staff issues

Client requirements

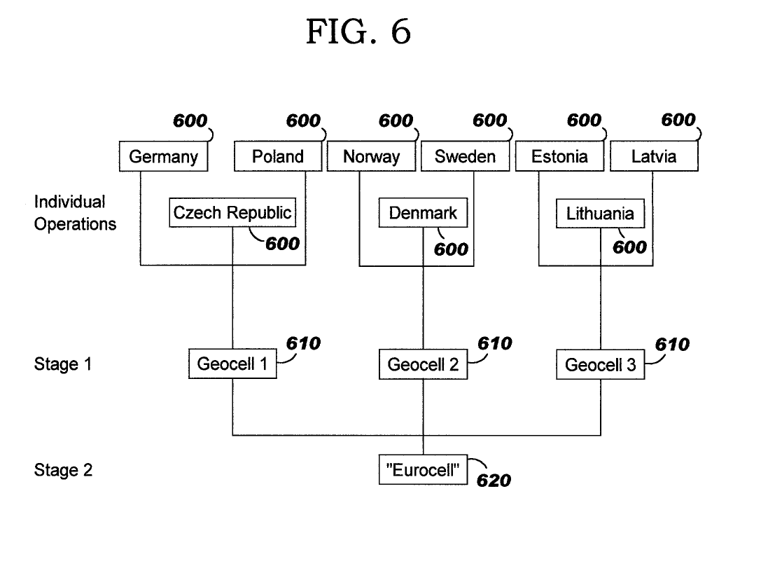

An example of such ‘two stage’ geocell activity is shown in the diagram of FIG. 6, which shows a method applied in two stages: a first stage providing a geocell (610) organization for the country individual operations (600), and a second stage to consolidate the organization at the European level (620).

We claim:

1. A project management method for optimizing Information Technology (IT) sites including skilled people groups and computer equipment, said method comprising the steps of:
determining, according to a project business need, a number of IT sites spread over a geographic area;
determining, according to a project technical need, the skilled people groups and computer equipment required inside the geographic area;
grouping and distributing, according to technical constraints, said skilled people groups and computer equipment over said IT sites inside the geographic area; and,
consolidating the IT sites of the geographic area by considering project cost parameters and geographic site location peculiarities.

2. The method of claim 1, further comprising the step of process and method standardization before the consolidating step, said process and method standardization step comprising the steps of:
listing processes and methods used in the IT sites as determined;
listing criteria allowing assessment of efficiency of said processes and methods in the IT sites as determined and according to the skilled people groups and computer equipment as determined, grouped, and distributed;
determining best processes and methods according to values of said criteria; and,
implementing the best processes and methods in the IT sites as determined.

3. The method of claim 2 wherein the step of determining the best processes and method further comprises the steps of:
entering in a database the values of said criteria;
creating with a graphic user interface an evolutionary image of the values of the criteria; and
analyzing the image for determining the best processes and methods.

4. The method of claim 3 further repeating, after the step of implementing the best processes and methods, the step of listing criteria, the step of determining best processes and methods, and the step of implementing the best processes and methods.

5. The method of claim 3, further repeating, after the step of determining best processes and methods, the step of listing criteria and the step determining best processes and methods.

6. The method of claim 1 wherein the IT sites are spread over more than one geographic area.

7. The method of claim 1, further comprising a step of determining, before the step of determining skilled people groups and computer equipment, a management organization for the geographic area.

8. The method of claim 1, further comprising after each step, a step of updating a project management tool displaying a time for executing each step of the method of claim 1.
